(19) United States
(12) Patent Application Publication
(10) Pub. No.: US 2005/0161058 A1
(43) Pub. Date: Jul. 28, 2005

(54) Spider silk dental floss

(76) Inventor: Israel Yerushalmy, Tel Aviv (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/763,325

(22) Filed: Jan. 26, 2004

(51) Int. Cl. A61C 15/00

(52) U.S. Cl. 132/321

(57) ABSTRACT

Dental floss that includes at least one filament made of spider silk.

### FIELD OF THE INVENTION

This invention relates generally to dental floss and specifically to dental floss with enhanced strength characteristics, e.g., made of spider silk.

### BACKGROUND OF THE INVENTION

It is generally recognized by the dental profession that different kinds of plaque, which may be found between the interproximal surfaces of teeth, are a major cause of both dental decay and inflammatory periodontal disease. Plaque contains many kinds of microbial organisms, and uses sugars and other fermentable carbohydrates to produce polymers that bind the organisms to the surface of teeth and acids that cause their demineralization. If not removed, plaque may eventually form calculus, a mineralized bacterial plaque deposit found on teeth, restorations, and other solid oral structures. The presence of calculus can seriously irritate gum tissues and otherwise affect oral hygiene. Accordingly, dental professionals have always recommended flossing in addition to the conventional practice of using a brush and dentifrice, because flossing helps clear the interproximal surfaces of the teeth in a manner that a toothbrush, with or without a dentifrice, cannot achieve.

However, flossing is unfortunately not practiced by the majority of people and there is still room for improvement in dental flosses.

### SUMMARY OF THE INVENTION

The present invention seeks to provide a novel dental floss that includes spider silk, as is described more in detail hereinbelow.

### DETAILED DESCRIPTION OF EMBODIMENTS

Silk is generally regarded as a proteinaceous substance secreted from glands present in some, but not all, invertebrates of the genera Arthropoda. Silk production is a characteristic of all spiders (e.g., orb-weaving spiders) and is also known among various mites, mantids, moths and beetles.

Mechanical properties of orb-weaving spider silk are generally considered to be the following: tensile strength in the range of 0.5-2.7 GPa; Young's modulus in the range of 0.003-10 GPa; toughness approximately 160 MJ/m³; and yield strain in the range of 0.27-3.0.

In general, spider silk may be initially stiff, but as the load is increased, the fiber becomes very elastic before it reaches its breaking point. Thus, spider silk has the advantage of having both high strength and elastic properties.

U.S. Pat. 6,268,169, the disclosure of which is incorporated herein by reference, describes a type of man-made spider silk. Considerable difficulty has been encountered in attempting to solubilize and purify natural spider silk while retaining the molecular-weight integrity of the fiber. The silk fibers are insoluble except in very harsh agents such as LiSCN, LiClO₄, or 88% (vol/vol) formic acid. Once dissolved, the protein precipitates if dialyzed or if diluted with typical buffers. Another disadvantage of spider silk protein is that only small amounts are available from cultivated spiders, making commercially useful quantities of silk protein unattainable at a reasonable cost. Additionally, multiple forms of spider silks are produced simultaneously by any given spider. The resulting mixture has less application than a single isolated silk because the different spider-silk proteins have different properties and, due to solubilization problems, are not easily separated by methods based on their physical characteristics. Hence the prospect of producing commercial quantities of spider silk from natural sources is not a practical one and there remains a need for an alternate mode of production. The technology of recombinant genetics provides one such mode.

By the use of recombinant DNA technology it is now possible to transfer DNA between different organisms for the purposes of expressing desired proteins in commercially useful quantities.

Nexia Biotechnologies, located at 1000 St-Charles Avenue, Block B, Vaudreuil-Dorion, Quebec J7V 8P5, Canada, has developed a type of man-made spider silk using genetic engineering. Using transgenic goats, Nexia produces large volumes of complex recombinant proteins, commercially available as BioSteel®-M and BioSteel®-I.

In accordance with an embodiment of the present invention, the dental floss is made of spider silk. The spider silk may be natural or may be man-made, such as but not limited to, BioSteel®. The floss may be monofilament yarn or multifilament yarn, and the fibers may or may not be twisted.

The spider silk generally has excellent resistance to shredding and fraying. “Shredding” refers to breaking of yarn filaments of the floss during use. “Fraying” refers to the permanent separation of adjacent filaments of the floss during use. Frayed floss often results in the filaments becoming stuck between teeth, especially between teeth containing restorations. The spider silk generally does not leave remainders of fibers between teeth. Due to its excellent stretching capability and elasticity, the spider silk filaments may change in dimension (e.g., become thinner) in accordance with the spacing between teeth. The spider silk has excellent cleaning ability because it efficiently scrapes and brushes off matter from teeth.

The spider silk dental floss may be packaged as individual pieces or in a roll with a cutter for cutting pieces to any desired length. The spider silk dental floss may be provided in a variety of shapes other than filaments, such as but not limited to, strips and sheets and the like.

The floss may be coated with different materials, such as but not limited to, wax, polytetrafluoroethylene (PTFE) monofilament yarn for floss.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

1. Dental floss that includes at least one filament made of spider silk.

2. The dental floss according to claim 1, wherein said spider silk comprises artificially made spider silk proteins.

3. The dental floss according to claim 1, wherein said spider silk comprises BioSteel® fiber.

4. The dental floss according to claim 1, wherein said at least one filament comprises a monofilament yarn.

5. The dental floss according to claim 1, wherein said at least one filament comprises a multifilament yarn.

6. The dental floss according to claim 1, wherein said at least one filament is twisted.

7. The dental floss according to claim 1, wherein said at least one filament is not twisted.

8. The dental floss according to claim 1, wherein said at least one filament is coated with a material.

9. The dental floss according to claim 8, wherein said material comprises at least one of a wax and polytetrafluoroethylene (PTFE).
